(19) United States
(12) Patent Application Publication
(10) Pub. No.: US 2016/0299873 A1
(43) Pub. Date: Oct. 13, 2016

(54) Time Domain Sensor Systems, Devices, and Methods Using Enhanced Nonlinear Least-Squares Curve Fitting

(71) Applicant: SPAWAR Systems Center Pacific, San Diego, CA (US)

(72) Inventors: Charles Tally, San Diego, CA (US); Paul David Swanson, Santee, CA (US)

(21) Appl. No.: 15/189,981

(22) Filed: Jun. 22, 2016

Related U.S. Application Data
(63) Continuation-in-part of application No. 13/847,521, filed on Mar. 20, 2013.
Application No. 13/847,521 is a continuation-in-part of application No. 13/168,603, filed on Jun. 24, 2011.

(51) Int. Cl. G06F 17/15

(52) U.S. Cl. CPC G06F 17/15

(57) ABSTRACT

A time domain sensor system operable via a set of executable instructions storable in relation to a memory device for transforming output data by performing a nonlinear least-squares curve fitting, involving: a time domain sensor device having a mass-spring oscillator including a frame portion and a cantilever portion having a proximal end and a distal end, the cantilever portion coupled with the frame portion; and a plurality of proximity switches having a movable portion and a fixed portion in relation to the frame portion, each proximity switch of the plurality of proximity switches having at least one proximity tip, and each proximity switch configured to trigger in response to an acceleration experienced by the cantilever portion; and a processor operatively coupled with the time domain sensor device and configured to operate via the set of executable instructions for transforming the output data by performing a nonlinear least-squares curve fitting.

### CROSS-REFERENCE TO RELATED APPLICATION(S)

This document is a continuation-in-part application, claiming the benefit of, and priority through, the following documents: U.S. patent application Ser. No. 13/847,521, filed on Mar. 20, 2013, entitled “Method for Analytical Reconstruction of Digital Signals via Stitched Polynomial Fitting,” and U.S. patent application Ser. No. 13/168,603, filed on Jun. 24, 2011, entitled “Apparatus and Methods for Time Domain Measurement of Oscillation Perturbations,” all of which are hereby incorporated by reference in their entirety.

### FEDERALLY-SPONSORED RESEARCH AND DEVELOPMENT

The United States Government has ownership rights in the subject matter of the present disclosure. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 102575.

### BACKGROUND OF THE INVENTION

1. Technical Field

The present disclosure technically relates to sensing. Particularly, the present disclosure technically relates to time domain sensing. More particularly, the present disclosure technically relates to time domain sensing for improving timing information.

2. Description of Related Art

In the related art, curve fitting is the process of constructing a curve, or mathematical function, that has the best fit to a series of data points, possibly subject to certain constraints. Curve fitting can involve either interpolation, wherein an exact fit to the data is required, or smoothing, wherein a “smooth” function is constructed that approximately fits the data. Curve fitting is related to regression analysis which primarily focuses on questions of statistical inference, i.e., a degree of uncertainty that is present in a curve being fit to data observed with random errors. Fitted curves can aid data visualization to infer values of a function when no actual data are available and to summarize relationships among variables. Extrapolation refers to the use of a fitted curve beyond the range of the observed data and is subject to a degree of uncertainty as extrapolation is limited to the method used to construct the curve as much as extrapolation is limited to the observed data.

In related art nonlinear curve-fitting, given a function f(x) of a variable x tabulated at m values y₂=f(x₁), . . . , yₙ=f(xₘ), the assumed function is of a known analytic form, depending on n parameters f(x; λ₁, . . . , λₙ), and an “over-determined” set of m equations are as follows:

y₁=f(x₁; λ₁, λ₂, . . . , λₙ) (1)

yₘ=f(xₘ; λ₁, λ₂, . . . , λₙ) (2)

wherein equations (1) and (2) are solved to obtain the values λ₁, . . . , λₙ which best satisfy this system of equations. An initial “guess” for the dβi value is made and then a value for dβi is defined in equation (3) as follows:

dβᵢ=y_{i-f}(x₁; λ₁, . . . , λₙ) (3)

A linearized estimate for the changes dλᵢ needed to reduce dβᵢ to 0 is obtained in equation (4) as follows:

$$d {β}_{i} = {\sum }_{j = 1}^{n} \frac{\partial f}{\partial {λ}_{j}} d {λ}_{j} {\vert}_{{c}_{i} , λ} \qquad ( 4 )$$

for i=1, . . . m, where λ=(λ₁, . . . , λₙ), wherein dβᵢ is expressible in equation (5) in component form as follows:

dβᵢ=Aᵢⱼdβᵢ, (5)

wherein A is the m×n matrix in equation (6) as follows:

$${A}_{ij} = [ \begin{matrix}\frac{\partial f}{\partial \text{?}} & … & \frac{\partial f}{\partial \text{?}} \\ \frac{\partial f}{\partial \text{?}} & … & \frac{\partial f}{\partial \text{?}} \\ ⋮ & ⋱ & ⋮ \\ \frac{\partial f}{\partial \text{?}} & … & \frac{\partial f}{\partial \text{?}}\end{matrix} ] . \\ \text{?} \text{indicates text missing or illegible when filed} \qquad ( 6 )$$

In a more concise matrix form, dβ is expressible in equation (7) as follows:

dβ=Adλ, (7)

wherein dβ is an m-vector and dλ is an n-vector.

Subsequently, applying the transpose of A to both sides of equation (7) provides equation (8) as follows:

A^{T}dβ=(A^{T}A)dλ. (8)

thereby defining equations (9) and (10) as follows:

a=A^{T}A (9)

b=A^{T}dβ (10)

in terms of the known quantities A and dβ, and thereby providing the matrix equation (11) as follows:

adλ=b, (11)

wherein equation (11) is solvable for dλ using standard matrix techniques, such as Gaussian elimination. This offset is then applied to λ and a new dβ is calculated. By iteratively applying this procedure until the elements of dλ become smaller than some prescribed limit, a solution is obtained. This procedure does not converge well for some functions and improving convergence requires selecting initial values that are close to the best-fit value. The sum of square residuals is given by the expression R²=dβ·dβ after the final iteration.

Referring to FIG. 1, this graph illustrates an example of a nonlinear least-squares fit to a noisy Gaussian function, wherein an abscissa axis represents a duration T, and wherein an ordinate axis represents an amplitude A, accordance with the related art.

$$f ( x ; A , {x}_{0} , σ ) = A \text{?} \\ \text{?} \text{indicates text missing or illegible when filed} \qquad ( 12 )$$

wherein the thin solid curve 10 represent the initial guess, the dotted curves 20 represent intermediate iterations, and the heavy solid curve 30 represents the fit to which the solution converges. The actual parameters are (A, x_{α}, α)=(1, 20, 5), the initial guess was (0.8, 15, 4), and the converged values are (1.03105, 20.1369, 4.86022), with R²=0.148461. The partial derivatives used to construct the matrix A are in equations (13), (14), and (15) as follows:

$$\begin{matrix}\frac{\partial f}{\partial A} = \text{?} & ( 13 ) \\ \frac{\partial f}{\partial {x}_{0}} = \frac{A ( x - {x}_{0} )}{{σ}^{2}} \text{?} & ( 14 ) \\ \frac{\partial f}{\partial σ} = \frac{{A ( x - {x}_{0} )}^{2}}{{σ}^{2}} \text{?} . \\ \text{?} \text{indicates text missing or illegible when filed} & ( 15 )\end{matrix}$$

However, the foregoing related art curve-fitting techniques have not been applicable to time domain sensing. Therefore, a need exists for time domain sensing for improving timing information.

### SUMMARY OF THE INVENTION

To address at least the needs and challenges in the related art, the systems, devices, and methods of the present disclosure involve enhanced non-linear curve-fitting for improving timing information. In accordance with an embodiment of the present disclosure, a time domain sensor device comprises: a mass-spring oscillator, the mass-spring oscillator comprising a frame portion and a cantilever portion; and a plurality of proximity switches, each proximity switch of the plurality of proximity switches comprising at least one proximity tip, and each proximity switch configured to trigger in response to an acceleration experienced by the cantilever portion.

### BRIEF DESCRIPTION OF THE DRAWING

The above, and other, aspects, features, and uses of several embodiments of the present disclosure are further understood from the following Detailed Description of the Invention as presented in conjunction with the following several figures of the Drawings.

FIG. 1 is a graph illustrating an example of a nonlinear least-squares fit to a noisy Gaussian function, wherein an abscissa axis represents duration, and wherein an ordinate axis represents amplitude, in accordance with the related art.

FIG. 2A is a schematic diagram illustrating a time domain sensor device configured to use an enhanced least-squares curve fitting, in accordance with an embodiment of the present disclosure.

FIG. 2B is a schematic diagram illustrating a cantilever portion of the time domain sensor device, as shown in FIG. 2A, experiencing three possible modes of acceleration, by example only, in accordance with an embodiment of the present disclosure.

FIG. 2C is a graph illustrating output data relating to the cantilever portion, as shown in FIG. 2B, of the time domain sensor device, as shown in FIG. 2A, configured to experience and sense three possible modes of acceleration, by example only, wherein an abscissa axis represents duration, and wherein an ordinate axis represents amplitude, in accordance with an embodiment of the present disclosure.

FIG. 3 is a graph illustrating a generalized operation of a time domain sensor system, comprising a time domain sensor device, configured to experience a mass-spring oscillation, in accordance with an embodiment of the present disclosure.

FIG. 4 is a set of graphs illustrating various stages of real-time data transformation performable by a time domain sensor system, comprising a time domain sensor device, the system operable by a set of executable instructions for transforming the output data from the time domain sensor device using an enhanced nonlinear least-squares curve fitting, in accordance with an embodiment of the present disclosure.

FIG. 5 is a set of graphs illustrating various stages of data transformation made by a time domain sensor system operable by a set of executable instructions for transforming the output data from a time domain sensor device by performing an enhanced nonlinear least-squares curve-fitting, wherein measurement of parameters, such as a force and a “jerk” are more accurate than by using any related art technique, in accordance with an embodiment of the present disclosure.

FIG. 6 is a schematic diagram illustrating a time domain sensor system, comprising a time domain sensor device, in accordance with an embodiment of the present disclosure.

FIG. 7 is a flow diagram illustrating a method of fabricating a time domain sensor device, in accordance with an embodiment of the present disclosure.

FIG. 8 is a flow diagram illustrating a method of fabricating a time domain sensor system, comprising a time domain sensor device, in accordance with an embodiment of the present disclosure.

FIG. 9 is a flow diagram illustrating a method of improving timing information by way of a time domain sensor system, comprising a time domain sensor device, operating via a set of executable instructions for transforming the output data by performing a nonlinear least-squares curve-fitting, in accordance with an embodiment of the present disclosure.

Corresponding reference numerals or characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in a commercially feasible embodiment are often not depicted in order to facilitate a less obstructed view of these various embodiments of the present disclosure.

### DETAILED DESCRIPTION OF THE INVENTION

In accordance with embodiments of the present disclosure, time domain sensor systems, devices, and methods generally provide output data with accurate timing information relating to when a mass-spring oscillator passes known locations. The time domain sensor systems, devices, and methods of the present disclosure involve analyzing the output data by applying a curve fit thereto, wherein the output data comprises time data and position data, and whereby a plurality of system parameters, such as time-varying parameters, static parameters, and quasi-static parameters, are accurately measurable. The curve fit comprises a set of executable instructions for transforming the output data by performing a nonlinear least-squares curve-fitting, e.g., storable in a non-transitory memory device, in relation to at least one oscillation that accurately measures, not only at least one property, such as resonant frequency, amplitude of an oscillation, a damping coefficient, and a phase, of a mass-spring oscillator, such as included in a time domain sensor device, but also measures at least one perturbation to the oscillation, such as a direct current (DC), a time changing offset, an amplitude modulation, a non-resonant frequency component, an aliasing, and the like.

The time domain sensor systems, devices, and methods of the present disclosure further involve using a predetermined, or a user-defined, non-linear function with at least one parameter which approximates a motion, such as an oscillation, e.g., experienceable by a time domain sensor device, and which estimates an initial value of each parameter to be measured of the plurality of system parameters. The set of executable instructions for transforming the output data by performing an enhanced least-squares curve fitting iteratively converges upon the best combination of parameter values which fit the predetermined, or the user-defined, non-linear function to the output data from the time domain sensor device. The time domain sensor system, operable by the set of executable instructions, processes and transforms data relating to discrete time measurements generated from a time-domain sensor device to accurately measure various time domain sensor system parameters in an accuracy comprising a range of approximately less than 1 ppm.

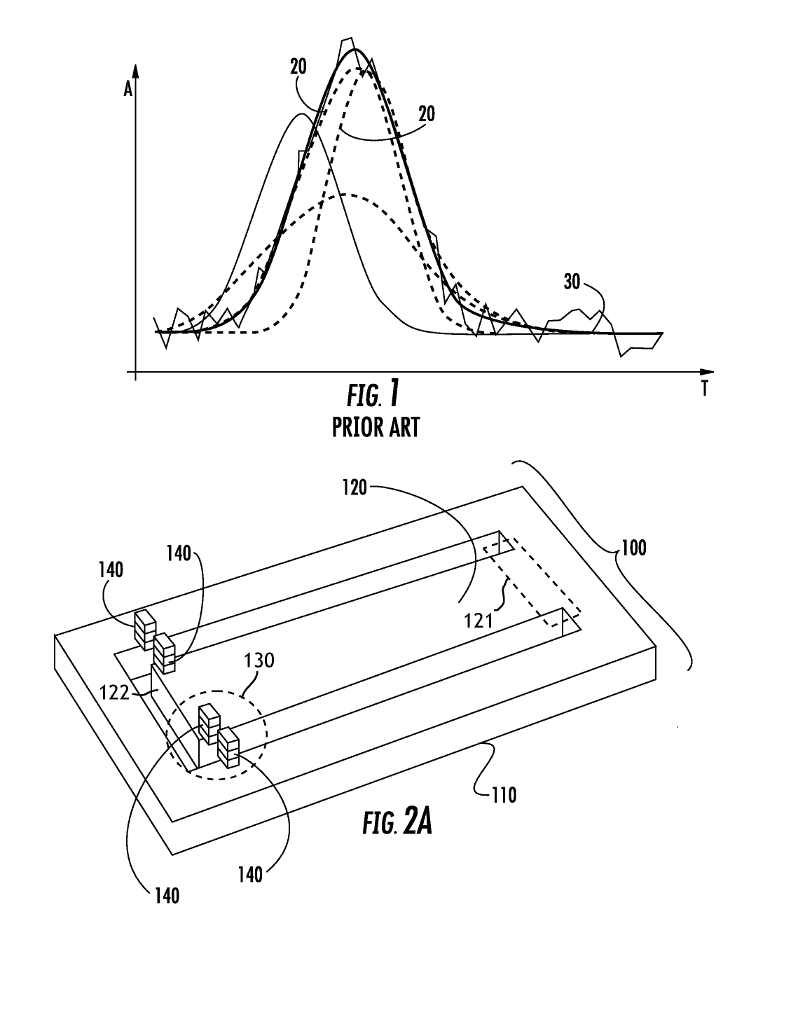

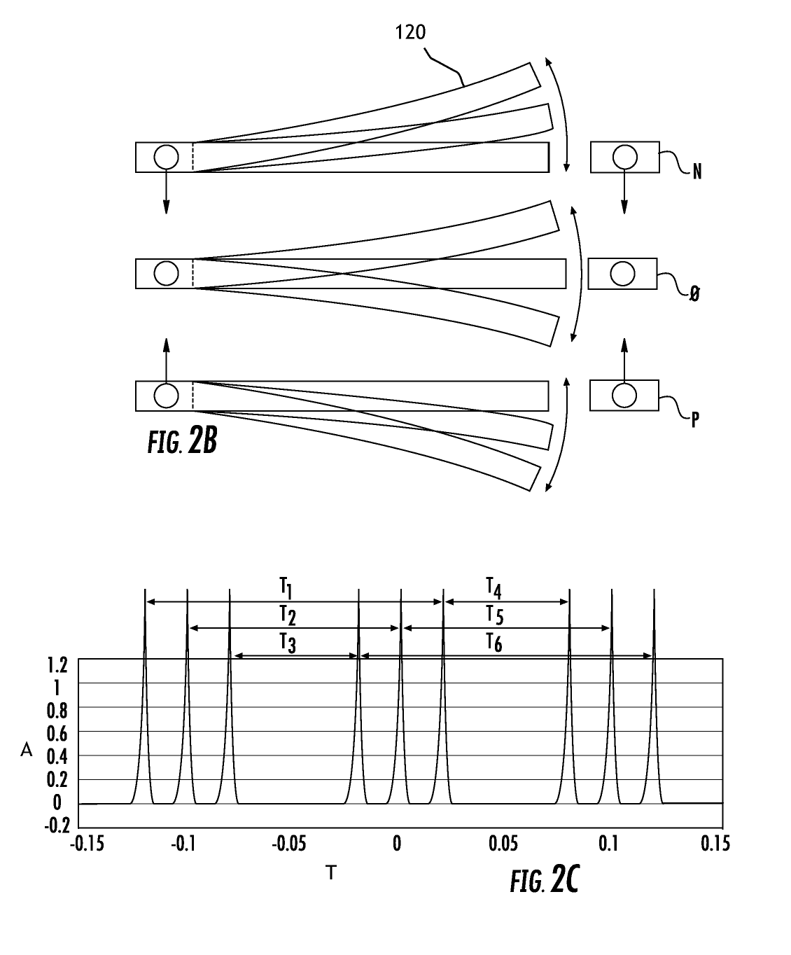

Referring to FIG. 2A, this diagram illustrates, in a perspective view, a time domain sensor device D, which comprises: a mass-spring oscillator 100, the mass-spring oscillator 100 comprising a frame portion 110 and a cantilever portion 120; and a plurality of proximity switches 130, each proximity switch 130 of the plurality of proximity switches 130 comprising at least one proximity tip 140, such as a pair of proximity tips 140, and each proximity switch 130 configured to trigger in response to an acceleration experienced by the cantilever portion 120, in accordance with an embodiment of the present disclosure. The frame portion 110 comprises a rigid material, such as silicon, quartz, a rigid metal, and any other suitable rigid material.

Referring to FIG. 2B, this diagram illustrates, in a side view, a cantilever portion 120 of the time domain sensor device D, as shown in FIG. 2A, configured to experience and sense three possible modes of acceleration, such as a negative acceleration, as indicated by a directional symbol N, a zero acceleration, as indicated by a directional symbol Ø, and a positive acceleration, as indicated by a directional symbol P, by example only, in accordance with an embodiment of the present disclosure. Still referring to FIG. 2B and referring back to FIG. 2A, the cantilever portion 120 is configured to experience and sense an acceleration if the time domain sensor device D is set into resonant motion, e.g., set into an oscillation. The cantilever portion 120 may be coupled with, or integrally formed with, the frame portion 110. The cantilever portion 120 may also comprise a rigid material, such as silicon, quartz, and any other suitable rigid material. The cantilever portion 120 may be coupled to the frame portion 110 via a coupling structure, such as fasteners, adhesives, or integral formation. The cantilever portion 120, having six sides, may be coupled with the frame portion 110 via one or two of the six sides.

Referring to FIG. 2C, this graph illustrates output data relating to the cantilever portion 120, as shown in FIG. 2B, of the time domain sensor device D, as shown in FIG. 2A, configured to experience and sense three possible modes of acceleration, by example only, wherein an abscissa axis represents time duration T, and wherein an ordinate axis represents amplitude A, in accordance with an embodiment of the present disclosure. The time domain sensor system S (FIG. 6), comprising the time domain sensor device D, is operable by the set of executable instructions for transforming the output data by performing an enhanced least-squares curve fitting from time interval data provided by triggering the plurality of proximity switches 130, whereby acceleration data is reconstructable.

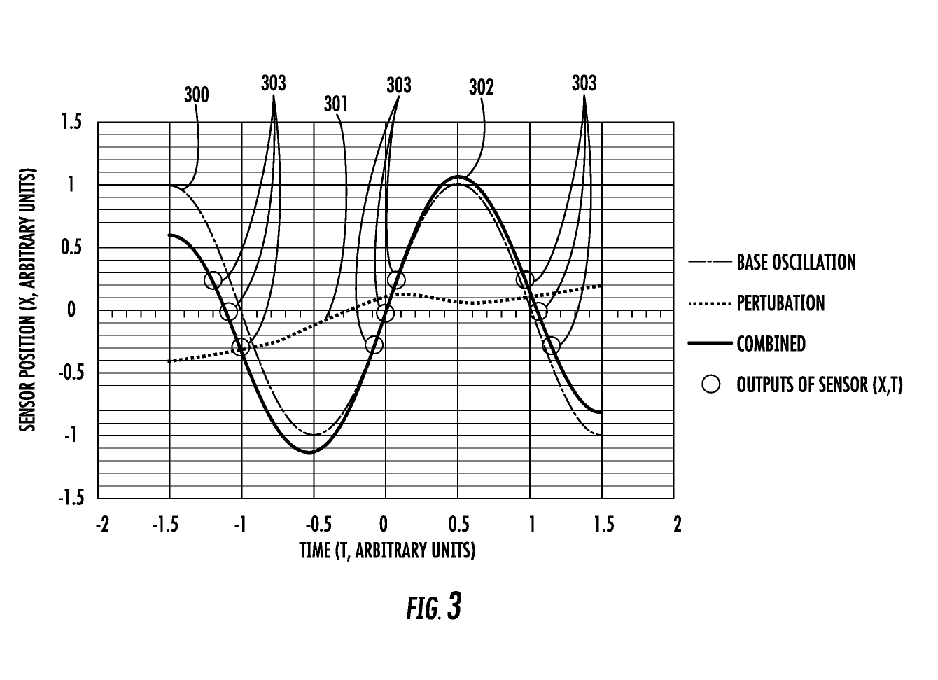

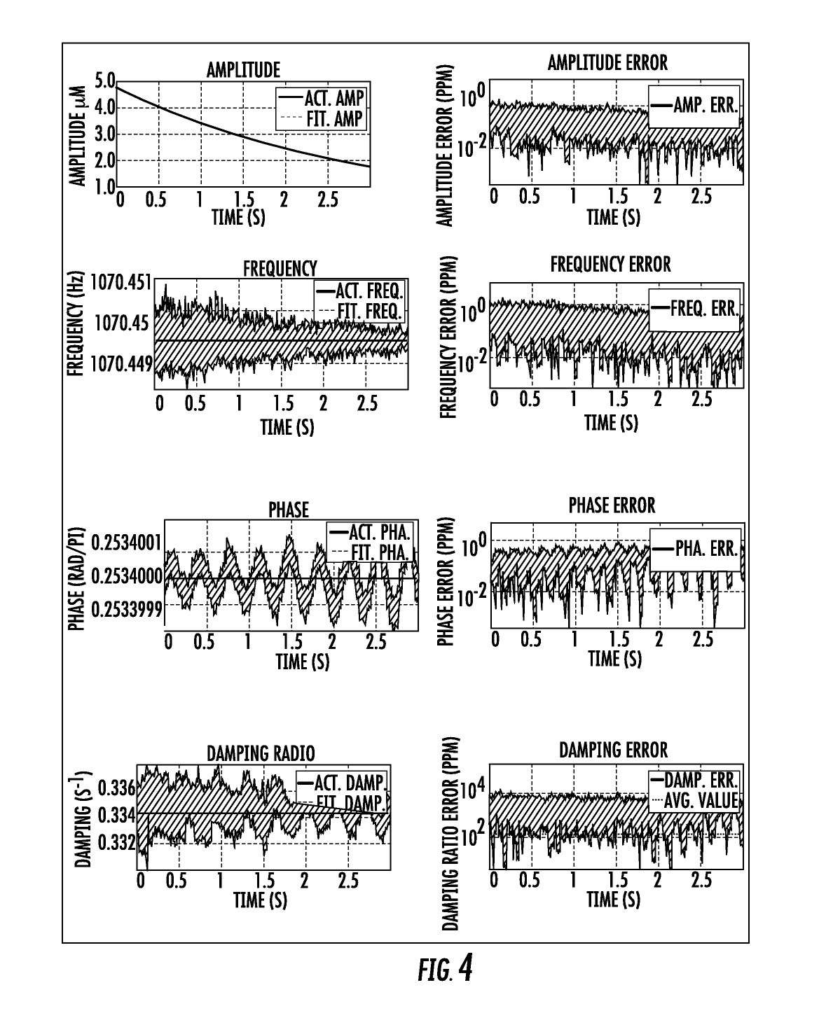

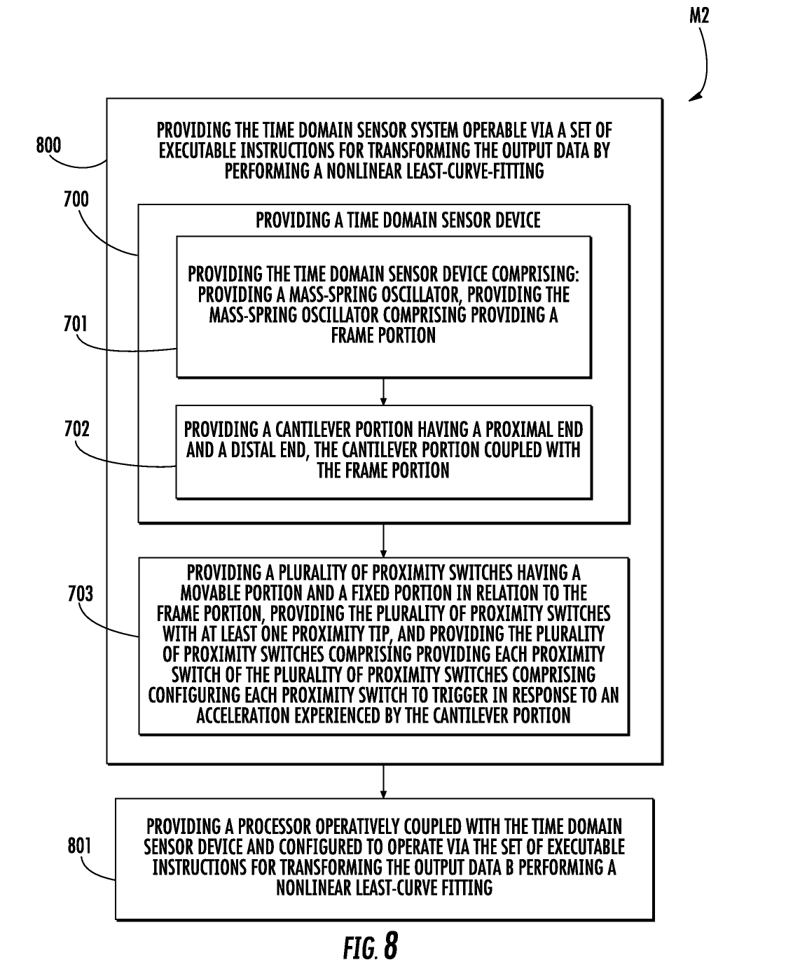

Referring to FIG. 3 and ahead to FIG. 8, this graph illustrates a generalized operation of a time domain sensor system S, comprising a time domain sensor device D, configured to experience a resonant oscillation, such as a mass-spring oscillation, in accordance with an embodiment of the present disclosure. The generalized overall behavior of the time domain sensor device D is depicted schematically in FIG. 3, wherein the mass-spring oscillation is represented as curve 300, wherein a time-varying perturbation to that oscillation is represented as curve 301, and wherein the combined signal, e.g. the sum of the curve 300 and the curve 301 (which is the actual motion of the mass) as represented by the curve 302. The proximity triggers in this graph are located at 0 and ±0.25 respectively; and the discrete outputs of the sensor device D are represented by circles 303. Using these output data points, the non-linear fit technique of the present disclosure estimates the values of A, ω, φ, and b (which, together, represent the curve 300 as a function of time) as well as the values of p₁, . . . , pₙ (represented by the curve 301 as a function of time if the selected function P(p₁, . . . , pₙ; t) is sufficient to adequately encapsulate the dynamics of the curve 301.

Still referring to FIG. 3 and ahead to FIG. 8, a qualitative description of several implementations of the system S using a method M3 are now discussed. For inertial applications, measuring the acceleration that a time domain sensor device D is experiencing is desirable. Specifically, in measuring the deflection that a mass-spring exhibits, the amount of deflection is linearly proportional to the amount of force the time domain sensor device D is experiencing (Hooke's Law). For inertial forces, the acceleration and force are also linearly related by the mass (Newton's 1st Law), e.g., of the mass-spring. If the mass-spring is oscillating, the acceleration experienced is proportional to the offset of the oscillation-center (FIG. 2A). Thus, in the method M3 of improving timing information by way of a time domain sensor system S, performing the step of processing the space-time data, as indicated by block 801 (FIG. 8), the appropriate choice off(t) for the device D is expressed in equation (15) as follows:

f(t)=A·sin(ωt+φ)+O (15)

wherein t=time, and wherein A, ω, and φ encapsulate information, such as amplitude, angular resonant frequency, and phase with respect to a clock of a time-to-digital converter (TDC), respectively relating to the resonant oscillation. Meanwhile, 0 is the offset of the oscillation center (proportional to the acceleration the sensor device D is experiencing).

Still referring to FIG. 3 and ahead to FIG. 8, by measuring the times tᵢ at which the plurality of proximity switches 130 of the time-domain sensor device D are triggered, the times tᵢ occurring when the mass passes determined triggering locations Xᵢ≈f(tᵢ), the system S, operating by way of the set of executable instructions, determines the best choice of the parameters A, ω, φ, and 0 to fit the function f(t) to the set of data points {xᵢ, tᵢ}. In doing so, the desired acceleration value (via 0) is obtained as well as information relating to time-domain sensor device D (via A, ω, and φ). Obtaining information relating to time-domain sensor device D is particularly useful in system S wherein the system-level performance depends upon accurate knowledge of the oscillator parameters. In inertial applications, for example, the function relating inertial acceleration to the offset 0 involves ω explicitly: a=ω² 0. Thus, in order to actually measure the desired acceleration information, both 0 and ω must be accurately determined. In the related art, w is assumed as remaining constant and is measured only once during calibration (FIG. 1). In the systems, devices, and methods of the present disclosure, the reality of operational environments is taken into account, such as changes, spring fatigue, etc., which can lead to slow variations in w over time. In the related art, w is not actively estimated, thereby leading to long-term performance degradation, e.g., “bias drift.”

Still referring to FIG. 3 and ahead to FIG. 8, as the device D is assumed to have a linearly changing acceleration, in accordance with embodiments of the present disclosure, the mass-spring oscillation is presumably damped, a different analytical function for better representing the actual physics experienced by the device D is selectable in equation (16) as follows:

f(t)=A·sin(ωt+φ)·e^{-bt}+O+C·t, (16)

wherein the damping coefficient b and linearly-varying offset C are now actively estimated in addition to the previously estimated parameters A, ω, φ, and 0. Estimating the damping coefficient (b) and linearly-varying offset (C), involves additional transformational features for achieving a best fit.

Still referring to FIG. 3 and ahead to FIG. 8, if the device D is assumed un-damped with no offset, but potentially has a sinusoidal noise source at a different frequency from the resonant frequency, then an appropriate choice of analytic function is shown in equation (17) as follows:

f(t)=A·sin(ωt+φ)+O+A_{N}·sin(ω_{N}t+φ_{N}), (17)

wherein the amplitude, the frequency, and the phase (A_{N}, ω_{N}, φ_{N}) of the noise signal are obtained.

Still referring to FIG. 3 and ahead to FIG. 8, the method M3 is implementable in relation to any perturbed oscillator device if the expected perturbation is representable by an analytic function P(p₁,p₂, . . . , pₙ; t). The oscillation experienced by the device D is shown in equation (18) as follows:

f(t)=A·sin(ωt+φ)·e^{-bt}+P(p₁ . . . pₙ; t), (18)

wherein the best fit to the parameters A, ω, φ, and b represent the base oscillation and the parameters p₁, . . . , pₙ describe the perturbation to that oscillation via the predetermined, or user-defined, function P(p₁, . . . , pₙ; t), e.g., the amplitude, the frequency, and the phase (A_{N}, ω_{N}, φ_{N}) of the noise signal in the previous example.

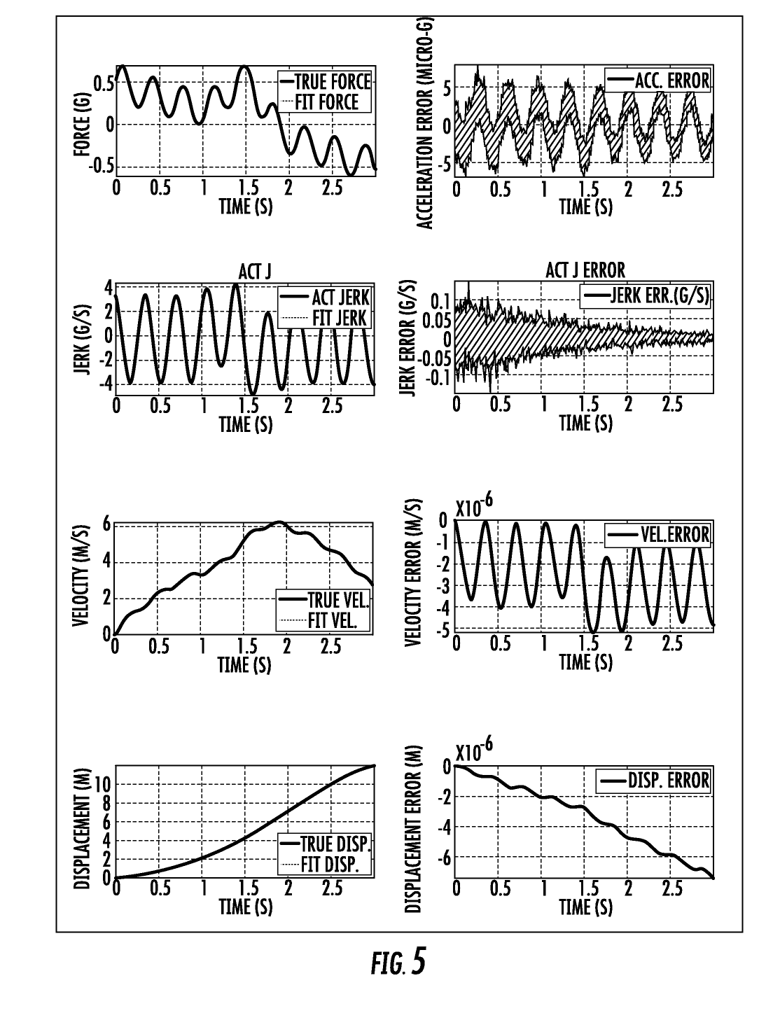

Still referring to FIG. 3 and ahead to FIG. 4, a description of the mathematical and numerical technique for finding the best fit follows. The present disclosure involves determining the best fit between a nonlinear function having n unknown parameters, f(t; P₁, P₂, . . . , Pₙ), and a set of k discrete data points {x₁, t₁}, {x₂, t₂}, {x₃, t₃}, {xₖ,tₖ}. For damped-oscillator devices undergoing perturbations: P₁=A, P₂=ω, P₃=φ, P₄=b, and P₅, . . . , Pₙ are the parameters of the predetermined, or user-defined, function for describing the perturbation. The vectors are defined in the expressions (19) as follows:

\vec{α}={P₁, P₂, . . . Pₙ}, \vec{x}={x₁, x₂, . . . xₖ}, and \vec{t}={t₁, t₂, . . . tₖ} (19)

Still referring to FIG. 3 and ahead to FIG. 4, the numerical process for finding the best fit is iterative in nature and involves: (1) defining a differentiable function that approximately describes the behavior of the system; and (2) providing a reasonable initial estimate for the value of each unknown parameter. Using data output from the time-domain sensor device D, an error vector is defined in equation (20) as follows:

\vec{ε}=\vec{x}−f(\vec{t}, \vec{α}), (20)

being the difference between the actual/known trigger locations x and the analytical function's estimate of \vec{x} at times \vec{t}, e.g., the times at which the sensor device D was located at \vec{x} and output a time stamp.

Still referring to FIG. 3 and ahead to FIG. 4, to find the optimal selection of the parameters P₁, P₂, . . . , Pₙ, the manner in which the analytic function changes is considered, e.g. its derivative, as each parameter changes, near each of the time-points of interest, e.g. tᵢ. Assembling all possibilities, the following matrix (21) is obtained:

$$\overleftrightarrow{δ} = [ \begin{matrix}\frac{\partial f}{\partial {P}_{1}} {\vert}_{{t}_{1} , \vec{α}} & … & \frac{\partial f}{\partial {P}_{n}} {\vert}_{{t}_{1} , \vec{α}} \\ \frac{\partial f}{\partial {P}_{1}} {\vert}_{{t}_{2} , \vec{α}} & … & \frac{\partial f}{\partial {P}_{n}} {\vert}_{{t}_{2} , \vec{α}} \\ ⋮ & ⋱ & ⋮ \\ \frac{\partial f}{\partial {P}_{1}} {\vert}_{{t}_{k} , \vec{α}} & … & \frac{\partial f}{\partial {P}_{n}} {\vert}_{{t}_{k} , \vec{α}}\end{matrix} ] \qquad ( 21 )$$

wherein the partial derivatives of f(\vec{t}, \vec{α}) are taken with respect to each parameter (P₁, . . . , Pₙ) treated as a variable during differentiation. These analytic derivatives are then evaluated numerically using the sensor measured time stamps \vec{t}, and the user-defined initial guesses of the parameter values \vec{α}. Qualitatively, the \vec{δ} matrix examines how the function f(\vec{t}, \vec{α}) varies with respect to each parameter near the relevant points in time.

Still referring to FIG. 3 and ahead to FIG. 4, next, original estimate of the parameters α by an ideal \vec{Δα} is altered so to minimize the magnitude of \vec{ε}. This alteration is performed by noting that the error vector can alternatively be represented in equation (22) as follows:

\vec{ε}= [symbol] ·\vec{Δα}. (22)

This expression now becomes a linear system, wherein \vec{ε} and [symbol] are known (being calculated from f(\vec{t}, \vec{α}), its partial derivatives, as well as the known points x and the measured data \vec{t}). To solve for \vec{Δα}, the transpose of [symbol] is applied, thereby providing the equation (23) as follows:

[symbol]

^{T}·\vec{ε}= [symbol] ^{T}· [symbol] ·\vec{Δα}. (23)

Still referring to FIG. 3 and ahead to FIG. 4, equation (23) is invertible by using numerical methods to solve for \vec{Δα}. With \vec{Δα} solved, the parameter estimate is improved via \vec{α}_{NEW}=\vec{α}_{OLD}+\vec{Δα}; and the foregoing steps are iteratively performed until \vec{α}_{NEW} and \vec{α}_{OLD} converge to a predetermined, or a user-specified, tolerance. Upon convergence thereto, the best fit is given by f(t, \vec{\vec{α}_{NEW}}), where \vec{α}_{NEW} comprises the most recent parameter values, whereby an analytic function, describing the behavior of the device D at any time t is obtained, and whereby the analytic function is generated from only a set of k discrete time measurements.

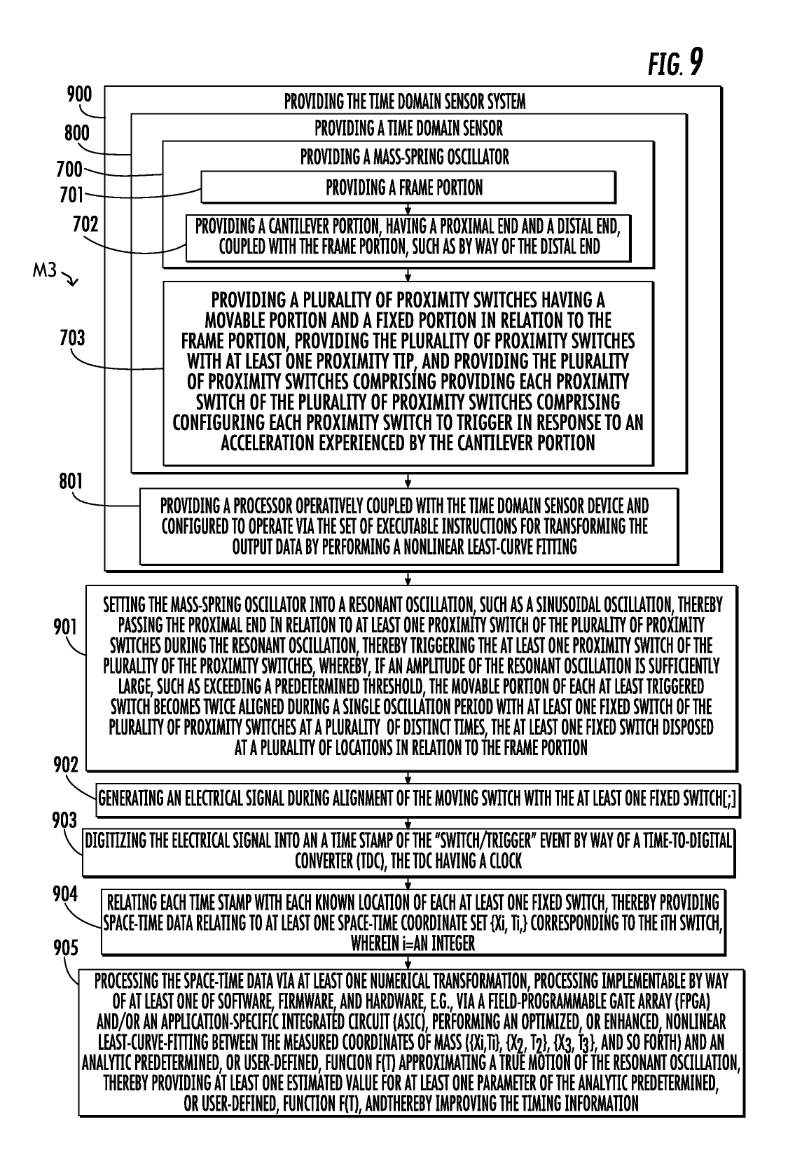

Referring to FIG. 4 and ahead to FIG. 9, this set of graphs illustrates various stages of real-time data transformation performable by a time domain sensor system S, comprising a time domain sensor device D, the system S operable by a set of executable instructions for transforming the output data from the time domain sensor device D using an enhanced nonlinear least-squares curve fitting, in accordance with an embodiment of the present disclosure. FIG. 4 further illustrates the real time measurement of the oscillator parameters A, ω, φ, b (dotted lines forming cross-hatched area on left-hand side graphs) with respect to their true values (solid lines on left-hand side graphs), e.g., as would be included in the method M3 (FIG. 9). (The real time measurement and the true values in the upper left graph of FIG. 4 overlap such that both lines appear to be one.) These true values correspond to the oscillation amplitude, resonant frequency, phase with respect to the system clock, and damping coefficient respectively of the sensor device D. The former three parameters are estimated in an accuracy range of approximately 1 ppm and less (right-hand side graphs, respectively). The damping is real-time estimated in an accuracy range of approximately 10⁴ ppm; and the damping is periodically estimated in an accuracy range of approximately 1 ppm and less by performing a second nonlinear fit on the measured amplitude data (uppermost left-hand side graph) to a decay function of the form f(t)_{damp}=A′e^{-b′t}, wherein an initial estimate of A′=5 μm and b′=0 are selectable.

Still referring to FIG. 4 and ahead to FIG. 9, a quantitative description follows relating to using the time domain sensor system S for improving timing information, e.g., via the method M3. To manifest the ability to accurately estimate device parameters, a time domain inertial micro-electro-mechanical system (MEMS) accelerometer is implemented. The MEMS accelerometer is modeled as a mass-spring system undergoing damped harmonic oscillations, which are offset by time-varying external forces as expressed in equation (24) as follows:

f(t)=A·sin(ωt+φ)·e^{-bt}+F+J·t. (24)

This mass-spring system is an n=6 parameter system, wherein A, ω, φ, and b respectively represent the amplitude, resonant frequency, phase, and damping coefficient of the mass-spring oscillation, and the offset is modeled to have a constant component F that is proportional to the inertial force and a component J that varies linearly in time and is proportional to the change in the inertial force called “jerk”. Thus, in this example, the perturbation is expressed in equation (25) is as follows:

P(F, J; t)=F+J·t (25)

Still referring to FIG. 4 and ahead to FIG. 9, the sensor device D is assumed to have six discrete triggering switches, such as the proximity switches 130, located at x={−1.25, −0.75, −0.25, 0.25, 0.75, 1.25} μm. The oscillator is assumed to have a resonant frequency near 1 kHz, be lightly damped, to have a user-induced initial oscillation amplitude of somewhere near ±5.0 μm, and to have an unknown phase with respect to the TDC clock. Thus, the initial estimates for these parameters are ω=2π·1 kHz, b=0, A=5.0 μm, and φ=0. The values of F and J are entirely unknown as they are the physical parameters to be measured by the accelerometer; and the values of F and J are both initially assumed to be zero.

Still referring to FIG. 4 and ahead to FIG. 9, the system S is configured to process time data from eighteen consecutive triggering instances (k=18), occurring over approximately 1.5 oscillation cycles to measure the six parameter values (A, ω, φ, b, F, and J). A timing jitter/error is assumed to exist on the order of 50 ps (50×10¹² seconds) due to the limitations of the TDC, the triggers' spatial inconsistency, and other electronics factors. This timing jitter is the primary contributor of error in the estimation of the six parameters.

Still referring to FIG. 4 and ahead to FIG. 9, over the course of this 1.5 cycle period (approximately 1.5/1 kHz=1.5 ms), the inertial force is assumed as being accurately described by the perturbation equation, such as equation (25), namely, by a constant plus a linearly changing parameter, e.g., F +J·t). In other words, if the inertial forces do not vary significantly over time scales of approximately 1.5 ms, the system S estimates all parameters accurately. If the inertial forces do vary significantly (non-linearly), over this time period, then the error in the estimation of all parameters will increase. In the latter case, to prevent error, additional terms are added to the perturbation equation, such as equation (25), to adequately encapsulate the perturbation's dynamics. This addition of terms to the perturbation equation requires solving for at least one additional parameter.

Still referring to FIG. 4 and ahead to FIG. 9, the inertial signal considered in a 3-second-long simulation is a combination of a linearly changing force (varying in a range of approximately 0.5 g initially to approximately −0.5 g in the end of a cycle, wherein 1 g=9.8 m/s², gravitational acceleration) with an approximately 2.84 Hz vibrational signal with an approximately 0.2 g amplitude, and a Gaussian “pulse” force of 0.5 g occurring at the halfway point of the cycle. These forces have frequency content similar to that of many real world inertial applications. More importantly, the frequency content of these components is sufficiently low (with respect to the ˜1 kHz oscillator's period) such that the enhanced least-squares curve fitting of the present disclosure converges nicely and provides an accurate estimate of all parameters of the sensor device D as well as the time-varying perturbation.

Still referring to FIG. 4 and ahead to FIG. 9, the measurement of the oscillator parameters (A, ω, φ, b) by the system S are plotted with the actual values. All estimates have average error magnitudes of less than approximately 1 ppm, with the exception of the damping parameter b having a peak error magnitude on the order of approximately 10⁴ ppm. The poor measurement of the damping parameter in the related art may involve related art devices that are incapable of distinguishing small exponential decays (damping) from linear decreases in the oscillation-center caused by the “jerk” parameter J.

Still referring to FIG. 4 and ahead to FIG. 9, to improve the measurement of the damping coefficient, the set of executable instructions of the present disclosure presume that the amplitude measurement is sufficiently good, and, thus, accurately shows the oscillator's amplitude decaying due to damping. Specifically, in the method M3, by performing a second nonlinear best-curve fit, such as a least-square fit, of the measured amplitude function to a simple decay function of the form f(t)_{damp}=A′e^{-b′t}, wherein the initial estimate of A′=5 μm, b′=0 are selectable, the estimation of the parameter b′ is improved to an accuracy range of approximately 0.0176 ppm. In the embodiments of the present disclosure, data relating to an ending point of a previous perturbation are used as data relating to a starting point for determining a subsequent, or next, perturbation, wherein a relative variability among a plurality of variable parameters is determinable and wherein a number of nonlinear best-curve fit iterations is increasable in relation to a portion of the plurality of variable parameters that vary more than a remaining portion of the plurality of variable parameters. The degree of variance in relation to each variable parameter is at least one of a predetermined value, a selectable value, and a calculable value.

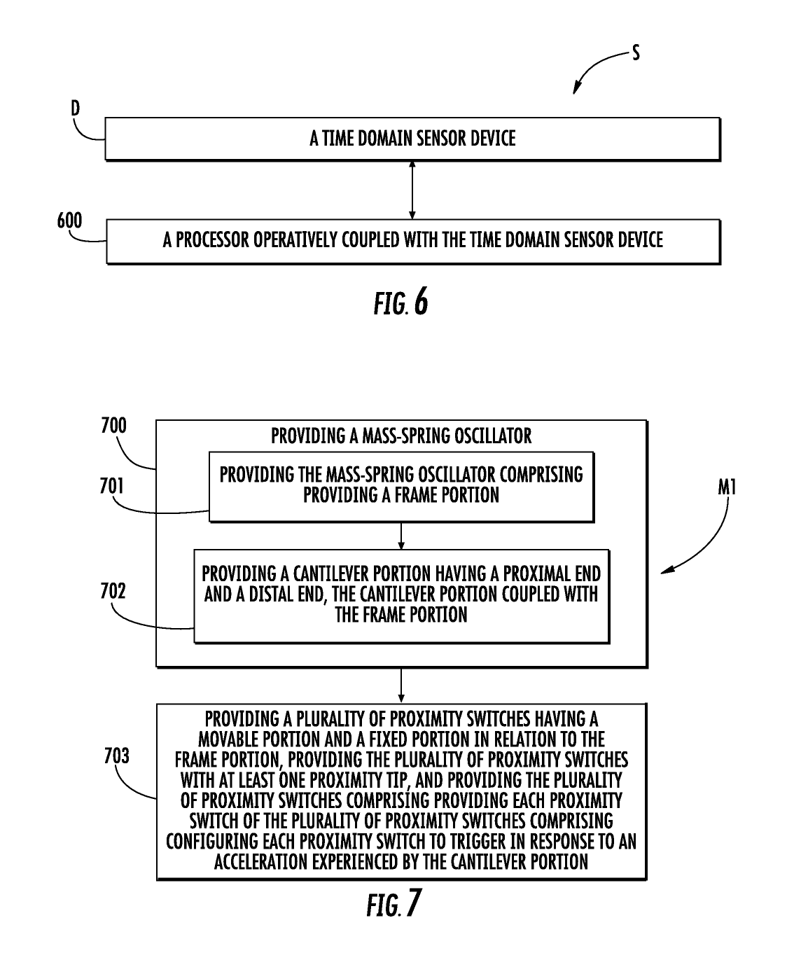

Referring to FIG. 5 and ahead to FIG. 9, this set of graphs illustrates various stages of data transformation made by a time domain sensor system S operable by a set of executable instructions for transforming the output data from a time domain sensor device D by performing an enhanced nonlinear least-squares curve-fitting, e.g., via the method M3, wherein measurement of parameters, such as a force and a “jerk” are more accurate than by using any related art technique, in accordance with an embodiment of the present disclosure. In FIG. 5, measurement of the inertial force, the change in inertial force called “jerk,” as well as the navigational velocity/position are shown (dotted lines on left-hand side graphs) as well as the actual values of these quantities (solid lines on left-hand side graphs). The dotted and solid lines on the left-hand graphs of FIG. 5 are so well aligned that they overlap and appear to be a single line in each of the left-hand graphs. Errors in the estimation of each of these quantities are also shown (solid lines on right-hand side graphs). The acceleration measurement is valid to within approximately 5 micro-g (uppermost right-hand side graph) and the primary contribution to the error arises from a 2.84-Hz sinusoidal inertial signal. After a displacement of more than 11 m (lowermost left-hand side graph), however, the navigational error of this device D is less than 811 m (lowermost right-hand side graph). This result corresponds to a relative navigational error in a range of approximately 0.8 ppm (defined as the navigational error divided by the total distance traveled).

Still referring to FIG. 5 and ahead to FIG. 9, the system S is configured to accurately measure the force F and the “jerk” J with great a greater accuracy, e.g., in an accuracy range of approximately 5 micro-g and less, wherein the primary error source may arise from the 2.84-Hz inertial component. Furthermore, by integrating the acceleration data numerically, an estimate for the navigational velocity of the sensor is obtained, thereby providing velocity data. By integrating this velocity data once more, the navigational position estimate of the sensor is provided. In FIG. 5, the data indicates that, during the three second simulation, the inertial force results in 11.58 meters of sensor displacement. The error in the measurement of that displacement is, however, only approximately 7.44 μm. Thus, the sensor has a relative navigational accuracy (defined as the error in navigational location divided by the total distance traveled) of less than one part per million believed to be unprecedented, and hitherto unknown, in the current state of the related art, e.g., in relation to MEMS inertial sensing.

Referring to FIG. 6, this schematic diagram illustrates a time domain sensor system S, comprising a time domain sensor device D, in accordance with an embodiment of the present disclosure. The time domain sensor system S comprises: a time domain sensor device D, the time domain sensor device D comprising: a mass-spring oscillator 100 (as shown in FIG. 2A), the mass-spring oscillator 100 comprising a frame portion 110 and a cantilever portion 120 having a proximal end 121 and a distal end 122, the cantilever portion 120 coupled with the frame portion 110; and a plurality of proximity switches 130 having a movable portion and a fixed portion in relation to the frame portion 110, each proximity switch 130 of the plurality of proximity switches 130 having at least one proximity tip 140, and each proximity switch 130 configured to trigger in response to an acceleration experienced by the cantilever portion 120; and a processor 600 operatively coupled with the time domain sensor device D and configured to operate via the set of executable instructions for transforming the output data by performing a nonlinear least-squares curve fitting.

Still referring to FIG. 6, the processor 600 is configured by the set of executable instructions to: generate an electrical signal during alignment of the moving switch with the at least one fixed switch; digitize the electrical signal into an a time stamp of the “switch/trigger” event by way of a time-to-digital converter; relate each time stamp with each known location of each at least one fixed switch, thereby providing space-time data relating to at least one space-time coordinate set {xᵢ, tᵢ} corresponding to the i^{th} switch, wherein i=an integer; process the space-time data via at least one numerical transformation, processing the space-time data implementable by way of at least one of software, firmware, and hardware; and perform an enhanced nonlinear least-squares curve-fitting between space-time data and a selectable analytic function approximating a true motion of the resonant oscillation, thereby providing at least one estimated value for at least one parameter of the selectable analytic function, and thereby improving the timing information.

Referring to FIG. 7, this flow diagram illustrates a method M1 of fabricating a time domain sensor device D, in accordance with an embodiment of the present disclosure. The method M1 comprises: providing a mass-spring oscillator 100, as indicated by block 700, providing the mass-spring oscillator 100 comprising providing a frame portion 110, as indicated by block 701, and providing a cantilever portion 120 having a proximal end 121 and a distal end 122, the cantilever portion 120 coupled with the frame portion 110, as indicated by block 702; and providing a plurality of proximity switches 130 having a movable portion and a fixed portion in relation to the frame portion 110, providing the plurality of proximity switches 130 comprising providing each proximity switch 130 of the plurality of proximity switches 130 with at least one proximity tip 140, and providing the plurality of proximity switches 130 comprising configuring each proximity switch 130 to trigger in response to an acceleration experienced by the cantilever portion 120, as indicated by block 703.

Still referring to FIG. 7, in the method M1, providing the cantilever portion 120 comprises coupling the cantilever portion 120 with the frame portion 110 via the distal end 122, providing each proximity switch 130 of the plurality of proximity switches 130 comprises providing each proximity switch 130 with at least one proximity tip 140, providing the at least one proximity tip 140 comprises providing a pair of proximity tips 140, providing the cantilever portion 120 comprises configuring the cantilever portion 120 to experience and sense at least three possible modes of acceleration, providing the cantilever portion 120 comprises configuring the cantilever portion 120 to experience and sense a negative acceleration, a zero acceleration, and a positive acceleration, and providing the cantilever portion 120 comprises configuring the cantilever portion 120 to experience and sense an acceleration if the time domain sensor device D is set into resonant motion.

Referring to FIG. 8, this flow diagram illustrates a method M2 of fabricating a time domain sensor device S, comprising a time domain sensor device D, in accordance with an embodiment of the present disclosure. The method M2 comprises: providing the time domain sensor system S operable via a set of executable instructions for transforming the output data by performing a nonlinear least-squares curve-fitting, as indicated by block 800, providing the time domain sensor system S comprising: providing a time domain sensor device D, as indicated by block 700, providing the time domain sensor device D comprising: providing a mass-spring oscillator 100, providing the mass-spring oscillator 100 comprising providing a frame portion 110, as indicated by block 701, and providing a cantilever portion 120 having a proximal end 121 and a distal end 122, the cantilever portion 120 coupled with the frame portion 110, as indicated by block 702; and providing a plurality of proximity switches 130 having a movable portion and a fixed portion in relation to the frame portion 110, providing the plurality of proximity switches 130 comprising providing each proximity switch 130 of the plurality of proximity switches 130 with at least one proximity tip 140, and providing the plurality of proximity switches 130 comprising configuring each proximity switch 130 to trigger in response to an acceleration experienced by the cantilever portion 120, as indicated by block 703; and providing a processor 600 operatively coupled with the time domain sensor device D and configured to operate via the set of executable instructions for transforming the output data by performing a nonlinear least-squares curve fitting, as indicated by block 801.

Still referring to FIG. 8, in the method M2, providing the processor 600 comprises configuring the processor 600 by way of the set of executable instructions to: generate an electrical signal during alignment of the moving switch with the at least one fixed switch; digitize the electrical signal into an a time stamp of the “switch/trigger” event by way of a time-to-digital converter; relate each time stamp with each known location of each at least one fixed switch, thereby providing space-time data relating to at least one space-time coordinate set {xᵢ, tᵢ} corresponding to the i^{th} switch, wherein i=an integer; process the space-time data via at least one numerical transformation, processing the space-time data implementable by way of at least one of software, firmware, and hardware; and perform an enhanced nonlinear least-squares curve-fitting between space-time data and a selectable analytic function approximating a true motion of the resonant oscillation, thereby providing at least one estimated value for at least one parameter of the selectable analytic function, and thereby improving the timing information.

Referring to FIG. 9, this flow diagram illustrates a method M3 of improving timing information by way of a time domain sensor system S, comprising a time domain sensor device D, operating via a set of executable instructions for transforming the output data by performing a nonlinear least-squares curve-fitting, in accordance with an embodiment of the present disclosure. The method M3 comprises: providing the time domain sensor system S, as indicated by block 900, providing the time domain sensor system S comprising: providing a time domain sensor device D, as indicated by block 800, providing the time domain sensor device D comprising providing a mass-spring oscillator 100, as indicated by block 700, providing the mass-spring oscillator 100 comprising providing a frame portion 110, as indicated by block 701, and providing a cantilever portion 120, having a proximal end 121 and a distal end 122, coupled with the frame portion 110, such as by way of the distal end 122, as indicated by block 702; and providing a plurality of proximity switches 130, having a movable portion and a fixed portion, in relation to the frame portion 110, providing the plurality of proximity switches 130 comprising providing each proximity switch 130 of the plurality of proximity switches 130 with at least one proximity tip 140, such as a pair of proximity tips 140, and providing the plurality of proximity switches 130 comprising configuring each proximity switch 130 to trigger in response to an acceleration experienced by the cantilever portion 120, as indicated by block 703; and providing a processor operatively coupled with the time domain sensor device and configuring the processor to operate via the set of executable instructions for transforming the output data by performing a nonlinear least-squares curve fitting, as indicated by block 801; setting the mass-spring oscillator 100 into a resonant oscillation, such as a sinusoidal oscillation, thereby passing the proximal end 121 in relation to at least one proximity switch 130 of the plurality of proximity switches 130 during the resonant oscillation, thereby triggering the at least one proximity switch 130 of the plurality of proximity switches 130, whereby, if an amplitude of the resonant oscillation is sufficiently large, such as exceeding a predetermined threshold, the movable portion of each at least triggered switch becomes twice aligned during a single oscillation period with at least one fixed switch of the plurality of proximity switches 130 at a plurality of distinct times, the at least one fixed switch disposed at a plurality of locations in relation to the frame portion 110, as indicated by block 901; generating an electrical signal during alignment of the moving switch with the at least one fixed switch, as indicated by block 902; digitizing the electrical signal into an a time stamp of the “switch/trigger” event by way of a time-to-digital converter (TDC), the TDC having a clock, as indicated by block 903; relating each time stamp with each known location of each at least one fixed switch, thereby providing space-time data relating to at least one space-time coordinate set {x₁, tᵢ} corresponding to the i^{th} switch, wherein i=an integer, as indicated by block 904; and processing the space-time data via at least one numerical transformation, processing implementable by way of at least one of software, firmware, and hardware, e.g., via a field-programmable gate array (FPGA) and/or an application-specific integrated circuit (ASIC), performing an optimized, or enhanced, nonlinear least-squares curve-fitting between the measured coordinates of the mass ({x₁, tᵢ}, {x₂, t₂}, {x₃, t₃}, and so forth) and an analytic predetermined, or user-defined, function f(t) approximating a true motion of the resonant oscillation, thereby providing at least one estimated value for at least one parameter of the analytic predetermined, or user-defined, function f(t), and thereby improving the timing information, as indicated by block 905.

Referring back to FIGS. 2-9, the features of the devices, systems, and methods in the embodiments of the present disclosure include, but are not limited to: (a) an ability to directly calculate the parameters of the carrier oscillator, e.g., A, ω, φ, b, in real time and with great accuracy, whereby monitoring these parameters, e.g., A, ω, φ, b, reduces long term bias drift otherwise occurring when these variables change slowly overtime, and thereby eliminating related art error in the incorrect assumption that such parameters are fixed constants by virtue of an initial “factory” calibration; (b) an ability to measure perturbations to the carrier oscillation via two methods: (i) if the perturbations change slowly with respect to the carrier oscillator period, the perturbation is estimable by measuring the time-varying offset of the carrier oscillation-center; and (ii) if the perturbation changes significantly over the course of a carrier oscillation, the perturbation is model-able by any predetermined, or user-defined, differentiable analytic function, whereby all relevant parameters of this differentiable analytic function are estimated (in addition to the carrier oscillator parameters), and thereby providing an accurate approximation of the time-varying perturbation; (c) a discrete timing-data producible by the time-domain sensor's proximity switches being process-able to yield an analytic expression, describing both the carrier oscillation and the perturbations of that oscillation at all times, whereby an estimate for the oscillator's behavior, or of the perturbation, or both, is obtainable by evaluating the analytic expression at any selectable time(s), whereby a unique analytic function is fit to each period of carrier oscillation, e.g., for a plurality of carrier oscillations, and whereby each unique analytic function is piece-wise stitchable or blendable together with an adjacent unique analytic function, thereby forming an analytic function spanning all oscillator periods, e.g., any time in which the device D is operating.

Still referring back to FIGS. 2-9, alternative embodiments of the present disclosure include, but are not limited to, alternative methods of improving timing information by way of a time domain sensor system S, comprising a time domain sensor device D, are applicable for fitting analytic functions to discrete time-data. Such alternative embodiments involve selecting a certain “type” of function, e.g., polynomial function, an exponential function, etc. The devices, systems, and methods of the present disclosure are alternatively applicable to a variety of other scenarios, (a) wherein the system behavior is adequately model-able by predetermined, or a user-defined, differentiable analytic function, and (b) wherein a sufficient initial estimate for the system parameters, whereby the iterative steps, e.g., in the method M3, are capable of converging on a solution. Mathematically, in performing the iterative steps, as the complexity of the selectable analytic function increases, the initial estimations must be closer for the iterative steps to converge on a solution, e.g., data relating to an ending point of a previous perturbation are used as data relating to a starting point for determining a subsequent, or next, perturbation, wherein a relative variability among a plurality of variable parameters is determinable and wherein a number of nonlinear best-curve fit iterations is increasable in relation to a portion of the plurality of variable parameters that vary more than a remaining portion of the plurality of variable parameters. The degree of variance in relation to each variable parameter comprises at least one of a predetermined value, a selectable value, and a calculable value. Although the method M3, itself, is not required to execute any inertial application software, any device which measures discrete outputs of an oscillation system's behavior may be adapted for use with the method M3 to obtain an analytic time-continuous estimate of the oscillation system's behavior.

Understood is that many additional changes in the details, materials, steps, and arrangement of parts, which have been herein described and illustrated to explain the nature of the embodiment, may be made by those skilled in the art within the principle and scope of the embodiment as expressed in the appended claims.

What is claimed:

1. A time domain sensor system operable via a set of executable instructions storable in relation to a non-transitory memory device for transforming the output data by performing a nonlinear least-squares curve fitting, comprising:
a time domain sensor device, the time domain sensor device comprising: a mass-spring oscillator, the mass-spring oscillator comprising a frame portion and a cantilever portion having a proximal end and a distal end, the cantilever portion coupled with the frame portion; and a plurality of proximity switches having a movable portion and a fixed portion in relation to the frame portion, each proximity switch of the plurality of proximity switches having at least one proximity tip, and each proximity switch configured to trigger in response to an acceleration experienced by the cantilever portion; and
a processor operatively coupled with the time domain sensor device and configured to operate via the set of executable instructions for transforming the output data by performing a nonlinear least-squares curve fitting.

2. The system of claim 1, wherein the cantilever portion is coupled with the frame portion via the distal end.

3. The system of claim 1, wherein each proximity switch of the plurality of proximity switches comprises at least one proximity tip.

4. The system of claim 3, wherein the at least one proximity tip comprises a pair of proximity tips.

5. The system of claim 1, wherein the cantilever portion is configured to experience and sense at least three possible modes of acceleration.

6. The system of claim 5, wherein the at least three possible modes of acceleration comprises a negative acceleration, a zero acceleration, and a positive acceleration.

7. The system of claim 1, wherein the cantilever portion is configured to experience and sense an acceleration if the time domain sensor device is set into resonant motion.

8. The system of claim 1, wherein the processor is configured by the set of executable instructions to:
generate an electrical signal during alignment of the moving switch with the at least one fixed switch;
digitize the electrical signal into an a time stamp of the “switch/trigger” event by way of a time-to-digital converter;
relate each time stamp with each known location of each at least one fixed switch, thereby providing space-time data relating to at least one space-time coordinate set {xᵢ, tᵢ} corresponding to the i^{th} switch, wherein i=an integer;
process the space-time data via at least one numerical transformation, processing the space-time data implementable by way of at least one of software, firmware, and hardware; and
perform an enhanced nonlinear least-squares curve-fitting between space-time data and a selectable analytic function approximating a true motion of the resonant oscillation, thereby providing at least one estimated value for at least one parameter of the selectable analytic function, and thereby improving the timing information.

9. A method of fabricating a time domain sensor system operable via a set of executable instructions storable in relation to a non-transitory memory device for transforming the output data by performing a nonlinear least-squares curve fitting, comprising:
providing the time domain sensor system operable via a set of executable instructions for transforming the output data by performing a nonlinear least-squares curve-fitting, providing the time domain sensor system comprising: providing a time domain sensor device, providing the time domain sensor device comprising: providing a mass-spring oscillator, providing the mass-spring oscillator comprising providing a frame portion, and providing a cantilever portion having a proximal end and a distal end, the cantilever portion coupled with the frame portion; and providing a plurality of proximity switches having a movable portion and a fixed portion in relation to the frame portion, providing the plurality of proximity switches comprising providing each proximity switch of the plurality of proximity switches with at least one proximity tip, and providing the plurality of proximity switches comprising configuring each proximity switch to trigger in response to an acceleration experienced by the cantilever portion; and
providing a processor operatively coupled with the time domain sensor device and configured to operate via the set of executable instructions for transforming the output data by performing a nonlinear least-squares curve fitting.

10. The method of claim 9, wherein providing the cantilever portion comprises coupling the cantilever portion with the frame portion via the distal end.

11. The method of claim 9, wherein providing each proximity switch of the plurality of proximity switches comprises providing each proximity switch with at least one proximity tip.

12. The method of claim 11, wherein providing the at least one proximity tip comprises providing a pair of proximity tips.

13. The method of claim 9, wherein providing the cantilever portion comprises configuring the cantilever portion to experience and sense at least three possible modes of acceleration.

14. The method of claim 13, wherein providing the cantilever portion comprises configuring the cantilever portion to experience and sense a negative acceleration, a zero acceleration, and a positive acceleration.

15. The method of claim 9, wherein providing the cantilever portion comprises configuring the cantilever portion to experience and sense an acceleration if the time domain sensor device is set into resonant motion.

16. The method of claim 9, wherein providing the processor comprises configuring the processor by way of the set of executable instructions to:
generate an electrical signal during alignment of the moving switch with the at least one fixed switch;
digitize the electrical signal into an a time stamp of the “switch/trigger” event by way of a time-to-digital converter;
relate each time stamp with each known location of each at least one fixed switch, thereby providing space-time data relating to at least one space-time coordinate set {xᵢ, tᵢ} corresponding to the i^{th} switch, wherein i=an integer;
process the space-time data via at least one numerical transformation, processing the space-time data implementable by way of at least one of software, firmware, and hardware; and
perform an enhanced nonlinear least-squares curve-fitting between space-time data and a selectable analytic function approximating a true motion of the resonant oscillation, thereby providing at least one estimated value for at least one parameter of the selectable analytic function, and thereby improving the timing information.

17. A method of improving timing information by way of a time domain sensor system, the method comprising:
providing the time domain sensor system operable via a set of executable instructions for transforming the output data by performing a nonlinear least-squares curve-fitting, providing the time domain sensor system comprising: providing a time domain sensor device, providing the time domain sensor device comprising: providing a mass-spring oscillator, providing the mass-spring oscillator comprising providing a frame portion, and providing a cantilever portion having a proximal end and a distal end, the cantilever portion coupled with the frame portion; and providing a plurality of proximity switches having a movable portion and a fixed portion in relation to the frame portion, providing the plurality of proximity switches comprising providing each proximity switch of the plurality of proximity switches with at least one proximity tip, and providing the plurality of proximity switches comprising configuring each proximity switch to trigger in response to an acceleration experienced by the cantilever portion; and providing a processor operatively coupled with the time domain sensor device and configuring the processor to operate via the set of executable instructions for transforming the output data by performing a nonlinear least-squares curve fitting;
setting the mass-spring oscillator into a resonant oscillation, thereby passing the proximal end in relation to at least one proximity switch of the plurality of proximity switches during the resonant oscillation, thereby triggering the at least one proximity switch of the plurality of proximity switches, whereby, if an amplitude of the resonant oscillation exceeds a predetermined threshold, the movable portion of each at least triggered switch becomes twice aligned during a single oscillation period with at least one fixed switch of the plurality of proximity switches at a plurality of distinct times, the at least one fixed switch disposed at a plurality of locations in relation to the frame portion;
generating an electrical signal during alignment of the moving switch with the at least one fixed switch;
digitizing the electrical signal into an a time stamp of the “switch/trigger” event by way of a time-to-digital converter;
relating each time stamp with each known location of each at least one fixed switch, thereby providing space-time data relating to at least one space-time coordinate set {xᵢ, tᵢ} corresponding to the i^{th} switch, wherein i=an integer;
processing the space-time data via at least one numerical transformation, processing the space-time data implementable by way of at least one of software, firmware, and hardware; and
performing an enhanced nonlinear least-squares curve-fitting between space-time data and a selectable analytic function approximating a true motion of the resonant oscillation, thereby providing at least one estimated value for at least one parameter of the selectable analytic function, and thereby improving the timing information.

18. The method of claim 17, wherein providing the cantilever portion comprises coupling the distal end with the frame portion.

19. The method of claim 17, wherein providing each proximity switch of the plurality of proximity switches comprises providing at least one proximity tip, and
wherein providing at least one proximity tip comprises providing a pair of proximity tips.

20. The method of claim 17,
wherein setting the mass-spring oscillator into a resonant oscillation comprises setting the mass-spring oscillator into a sinusoidal oscillation,
wherein digitizing comprises providing a TDC having a clock, and
wherein processing comprises using at least one of a field-programmable gate array and/or an application-specific integrated circuit.
